(19) United States
(12) Patent Application Publication
(10) Pub. No.: US 2012/0276324 A1
(43) Pub. Date: Nov. 1, 2012

(54) ADDITIVES COMPRISING CELLULOSE ETHERS FOR CERAMICS EXTRUSION

(76) Inventor: Roland Bayer, Walsrode (DE)

(21) Appl. No.: 12/520,591

(22) PCT Filed: Nov. 27, 2007
(86) PCT No.: PCT/EP07/10267

§ 371 Date: Dec. 4, 2009

(30) Foreign Application Priority Data
Dec. 22, 2006 (DE) 10 2006 062 141.7

(51) Int. Cl. C08L 1/26; C04B 35/10; C04B 35/581; C04B 35/56; C04B 35/195; C04B 35/185; C04B 35/565; C04B 35/58; C04B 35/584; C04B 35/46; C04B 35/563; C04B 35/01; C04B 35/20; C04B 35/515; C04B 35/52; C04B 35/50; C04B 35/18; B01J 31/26; B01J 29/06; B01J 31/06; B01J 31/38; B32B 3/12; C04B 35/622

(52) U.S. Cl. 428/116; 501/153; 501/87; 501/88; 501/154; 501/134; 501/1; 502/159; 502/62; 106/501.1; 106/181.1

(57) ABSTRACT

The present invention relates to specific additives comprising cellulose ether for improving the extrudability of ceramic masses and other masses which set as a result of baking or sintering, a corresponding extrusion process, the extrudates and their use.

The present invention relates to specific additives comprising cellulose ether for improving the extrudability of ceramic masses and other masses which set as a result of baking or sintering, a corresponding extrusion process, the extrudates and their use.

Water-soluble cellulose ethers have been used for many years as water retention agents, plasticizers and lubricants in the extrusion of ceramic masses and other masses which set as a result of baking or sintering to produce honeycomb bodies or other complicated profiles having similarly fine structures (see, for example: James S. Reed, Principles of Ceramics Processing, John Wiley & Sons, 1995, Chapter 23: Extrusion and Plastic Deformation Forming, p. 450 ff.)

The extrusion of ceramic masses and other masses which set as a result of baking or sintering is carried out by pressing a plastic mass through a die to produce any desired profiles, preferably honeycomb profiles as are used in catalysts or diesel soot particle filters. These masses can have various compositions and basically comprise a material, in particular a ceramic material, which is sinterable or hardens as a result of a ceramic baking process. They can further comprise catalytically active materials, fibers, aggregates and lightweight aggregates.

Technical and economic disadvantages of the usually extruded ceramic masses and other masses which set as a result of baking or sintering are high extrusion pressures which make operation of the extruders prematurely uneconomical due to high wear or high power costs. Another disadvantage is an unsatisfactorily low extrusion rate which reduces the capacity of the entire plant. The mass should undergo very little heating as a result of internal friction, since the consumption of cooling water or electric cooling likewise impairs the economics. The mass should be able to be extruded without cracks and form no cracks after drying of the extruded profile in air and subsequent baking or sintering. The cohesion of the particles in the extruded mass should be so high that even thin webs should be able to be extruded without problems. The shrinkage on drying and the shrinkage after baking should be minimal and virtually no crack formation should take place.

It has now surprisingly been found that the extrudability of such masses can be s improved considerably when (A) at least one cellulose ether, (B) at least one plasticizer and (C) at least one defoamer are added as individual components or as premixed additive.

The invention accordingly provides a process for the extrusion of ceramic masses or lo other masses which set as a result of baking or sintering, which comprises mixing a ceramic mass or other mass which sets as a result of baking or sintering with (A) at least one cellulose ether, (B) at least one plasticizer and (C) at least one defoamer as individual components or as premixed additive and subsequently extruding it.

The invention therefore also provides ceramic masses or other masses which set as a result of baking or sintering, which comprise (A) at least one cellulose ether, (B) at least one plasticizer and (C) at least one defoamer and also additives for the extrusion of ceramic masses and other masses which set as a result of baking or sintering which comprise (A) at least one cellulose ether, (B) at least one plasticizer and (C) at least one defoamer.

For the purposes of the present invention, ceramic masses and other masses which set as a result of baking or sintering are all masses which comprise at least one of the components listed below which can be baked or sintered by baking or sintering alone or with addition of other sintering aids:

alumina; aluminum nitride and aluminum carbide; kaolin; cordierite; mullite; silicon carbide; silicon boride; silicon nitride; titanium dioxide; titanium carbide; boron carbide; boron oxide; silicates and sheet silicates such as clay, bentonites, talc; silicon metal; carbon as carbon black or graphite; ground glass; other metal oxides such as rare earth oxides; zeolites and related substances.

The term “ceramic masses and other masses which set as a result of baking or sintering” does not include hydraulic binders such as cement or gypsum and masses based on cement or gypsum. These hydraulic binders set as a result of incorporation of water into the crystal lattice.

The above-mentioned masses can also comprise fibers which leave behind pores after baking or remain in the mass and thus increase the flexural strength.

For the present purposes, fibers are all types of natural or synthetic fibers such as fibers based on cellulose, bamboo, coconut, polyethylene, polypropylene, polyamide, polyacrylonitrile, carbon, glass, ceramic and other mineral fibers. Their fiber lengths and thicknesses can be varied within wide ranges.

Suitable cellulose ethers (A) are, in particular, ionic cellulose ethers such as sulfoethylcellulose or carboxymethylcellulose and salts thereof, or nonionic cellulose ethers such as alkylcelluloses, hydroxyalkylalkylcelluloses or hydroxyalkylcelluloses, in particular methylcellulose, methylhydroxyethylcellulose, methylhydroxypropylcellulose, hydroxyethylcellulose, ethylhydroxyethylcellulose, methylethylhydroxyethylcellulose, methylhydroxyethylhydroxypropylcellulose, methylhydroxyethylhydroxybutylcellulose or cellulose ethers which at the same time comprise methyl groups and longer-chain hydrophobic side chains as well as mixtures of the above-mentioned products.

The viscosities of the above-mentioned cellulose ethers are generally from 400 to 200 000 mPa·s, determined in a 2% by weight aqueous solution at 20° C. in a Haake rotational viscometer.

Suitable plasticizers (B) are, for example, casein; polycarboxylic acids and salts thereof; polymers which comprise both carboxylic acid monomers or their salts and carboxylate ether monomers, carboxylic ester monomers and other carboxylic acid derivatives, crosslinking bisacrylates and similar monomers as well as mixtures of the above-mentioned products. Among the plasticizers, preference is given to: homopolymers, copolymers and terpolymers of acrylic, methacrylic, crotonic, maleic, fumaric acid and similar monofunctional and bifunctional acids and also their salts, esters and ethers. Examples of ethers are polyalkylene glycol mono(meth)acrylates such as triethylene glycol monoacrylate and polyethylene glycol monoacrylate (having a polyethylene glycol molar mass of 200-2000 g/mol) s and also unsaturated polyalkylene glycol ethers without an acid group. Particularly preferred are: homopolymers, copolymers and terpolymers of acrylic and methacrylic acid, their bifunctional acids and also their salts, esters and ethers. Examples of ethers are polyalkylene glycol mono(meth)acrylates such as triethylene glycol monoacrylate and polyethylene glycol monoacrylate (having a polyethylene glycol molar mass of 200-2000 g/mol) but also unsaturated polyalkylene glycol ethers without an acid group.

Plasticizers here are expressly not from the class of melamine sulfonates or melamine-formaldehyde sulfonates, naphthalene sulfonates, lignosulfonates or is mixtures thereof.

Particularly preferred plasticizers are polycarboxylic acid copolymers and salts thereof.

Suitable defoamers (C) are, in particular, pure substances or mixtures in liquid or solid form which comprise at least one of the following: alkylene glycol homopolymers, copolymers, terpolymers and block copolymers, for example based on ethylene oxide or propylene oxide, adducts of alkylene oxides, alkylene glycol ethers of higher alcohols, fatty acid esters, alkylene glycol fatty acid esters, sorbitol fatty acid esters, polyoxyalkylene sorbitol fatty acid esters, addition products of ethylene oxide and propylene oxide and acetylene, phosphate esters such as tributyl phosphate, sodium octylphosphate and the like and also all compounds containing polyether groups or mixtures containing polyether groups which have a defoaming action as well as mixtures of the above-mentioned products.

Particularly preferred are alkylene glycol homopolymers, copolymers, terpolymers and block copolymers, for example based on ethylene oxide or propylene oxide, adducts of alkylene oxides, alkylene glycol ethers of higher alcohols, fatty acid esters, alkylene glycol fatty acid esters and the like and also all compounds containing polyether groups or mixtures containing polyether groups which have a defoaming action.

Very particular preference is given to alkylene glycol homopolymers, copolymers, terpolymers and block copolymers, for example based on ethylene oxide or propylene oxide, adducts of alkylene oxides, alkylene glycol ethers of higher alcohols and also all compounds containing polyether groups or mixtures containing polyether groups which have a defoaming action.

Apart from the components (A) to (C) mentioned as important for the purposes of the invention, the masses can also comprise further constituents such as hydrophobicizing agents, redispersion powders, superabsorbents based on crosslinked acrylates and polysaccharides, lubricants (for example polyethylene oxide homopolymers, copolymers and terpolymers), surfactants, accelerators, retardants, fatty acids and esters thereof, polymers based on acids, salts, amides and esters of acrylic acids and methacrylic acids, polyvinyl alcohols including their derivatives and polymers based on urethanes.

The components (A) to (C) are used in the following ratios relative to one another:

The proportion of component (A) based on the total amount of (A), (B) and (C) is preferably from 10 to 91% by weight, particularly preferably from 18 to 91% by weight, very particularly preferably from 25 to 91% by weight.

The proportion of component (B) based on the total amount of (A), (B) and (C) is preferably from 8 to 70% by weight, particularly preferably from 8 to 65% by weight, very particularly preferably from 8 to 60% by weight.

The proportion of component (C) based on the total amount of (A), (B) and (C) is preferably from 1 to 20% by weight, particularly preferably from 1 to 17% by weight, very particularly preferably from 1 to 15% by weight.

The amount of (A), (B) and (C), viewed as a mixture, used in the ceramic mass or other mass which sets as a result of baking or sintering is typically from 0.3 to 10% by weight, preferably from 0.7 to 9% by weight, particularly preferably from 1 to 8% by weight, in each case based on the total formulation.

(A), (B) and (C) can be added to the mass to be extruded either as a prefabricated mixture or else by stepwise addition of the individual components.

The invention further provides the extrudates obtainable by the process of the to invention, shaped bodies obtainable therefrom by thermal treatment and their use.

### EXAMPLES

As cellulose ether (A), use was made of a methylcellulose Walocel M-20678, Wolff Cellulosics GmbH, Germany, viscosity according specification: 75 000-85 000 mPa·s (of a 2% aqueous solution at 20° C., Shear-rate 2.55 s⁻¹ determined in a Haake rotational viscometer).

As plasticizer (B), use was made of Melflux 2651 F, BASF, Germany. This is a polycarboxylate ether.

As defoamer (C), use was made of Agitan P 803, Miinzing Chemie, Germany. This is a defoamer based on alkane/glycol applied to a support material.

The additive was prepared by mixing the components (A) to (C) in the amounts indicated in the table below.

Procedure for the Extrusion Experiments

35 parts by weight of silicon carbide SiC Dunkel Mikro F 280 (manufactured by ESK-SiC GmbH, Frechen, Germany), 35 parts by weight of silicon carbide SiC Dunkel Mikro F 360 (manufactured by ESK-SiC GmbH, Frechen, Germany), 30 parts by weight of silicon carbide SiC SM 10 (manufactured by ESK-SiC GmbH, Frechen, Germany) and 4 parts by weight (based on 100 parts by weight of silicon carbide) of the additive according to the invention were firstly mixed dry in a fluidized-bed mixer (manufactured by Lodige, Germany) until homogeneous, water at 20° C. was subsequently added, the mass was mixed further and kneaded in a kneader (manufactured by AMK, Aachen, Germany) for a few minutes. The mass was then immediately introduced into the feed trough of a single-screw extruder maintained at 20° C. (Handle 8D, screw diameter 8 cm, from Handle, Miihlacker, Germany). The mass was extruded through a perforated plate and passed through the vacuum chamber for degassing. It was then firstly strained (i.e. pressed through to a screen having a mesh size of 0.4 or 0.2 mm in order to free the mass of aggregates) and subsequently extruded through a honeycomb die and discharged onto a conveyor belt. To be able to see differences between cellulose ethers which lubricate well and lubricate poorly, the cooling was switched off on the extruder after commencement of the experiment and the heating of the mass during the experiment was measured.

All masses extruded in this way were set to a customary consistency (Shore hardness =10.0-11.5) by means of a water to solids ratio (W/S ratio) based on their water requirement. The consistency is a measure of the stiffness of the mass.

| | | | | | Susceptibility to | | |
|---|---|---|---|---|---|---|---|
| Cellulose | | | Pressure | Cohesion of | cracking of the | Temperature | |
| ether | | | at the | the mass | mass on bending | rise in the mass | |
| composition | | Shore | 200 cpsi | (+++/++/+/ | through an angle | during extrusion | |
| (A:B:C) | W/S | hardness | die (bar) | 0/−/−−/−−−) | of 90° | (° C.) | Remarks |
| 100:0:0 | 0.165 | 10.5-11.5 | 46 | + | some cracks | <10° C. | not according to the |
| | | | | | | | invention, B and C |
| | | | | | | | absent |
| 67:28:5 | 0.165 | 10-11.5 | 41 | +++ | no cracks | <10° C. | according to the |
| | | | | | | | invention |
| 91:7.25:1.75 | 0.18 | 10-11.5 | 45 | ++ | a few cracks | <10° C. | according to the |
| | | | | | | | invention |
| 89.5:10:0.5 | 0.165 | 10-11.5 | 46 | + | some cracks | <10° C. | according to the |
| | | | | | | | invention |
| 94.5:5:0.5 | 0.165 | 10-11.0 | 44 | + | some cracks | <10° C. | according to the |
| | | | | | | | invention |

W/S is the water/solids factor. The amount of water used was calculated only on the basis of silicon carbide.

The stiffness of the mass was tested on the freshly strained samples. If a mass is too stiff when extruded, the greater friction of the particles against one another and against the extruder walls leads to a higher power consumption, to increased wear and heating of the mass; if the mass is too soft when extruded, the shape of the extrudates is not stable.

Pressure is the pressure measured just before passage of the mass through the honeycomb die. A 200 cpsi die (web thickness=0.30 mm) (cpsi is the number of cells per square inch) was used.

Cohesion is the cohesion of the particles. It is necessary so that web cracks are not formed in complex die geometries.

The test for susceptibility to cracking on bending of the extrudate simulates real conditions, since the transport of industrially produced honeycombs from the conveyor belt (downstream of the extruder) to drying is frequently carried out manually and the still plastic mass can distort slightly during this procedure.

The temperature of the strained and extruded masses was measured by means of a noncontact infrared thermometer after leaving the die; these temperatures correspond to those measured via the temperature sensor built into the die head.

Experimental Results:

In the comparative experiment which is not according to the invention, it is found that the pure cellulose ether alone gives passable although not very economical and technically advantageous extrusion results. The higher the extrusion pressure is, the higher is the adverse effect on the maintenance costs of the plant because of the higher abrasion which it causes. The advantage of the cellulose ether mixture(s) according to the invention is also apparent in terms of the cohesion of the extruded mass and crack formation on bending of the extruded honeycomb.

The honeycombs are subjected to increased mechanical stress during transport of the honeycombs from the extruder via the drying chambers to the furnaces, so that a reduced proportion of rejects can be expected when the cohesion is better and the susceptibility to cracking is lower.

1. A process for the extrusion of ceramic masses or other masses which set as a result of baking or sintering, which comprises
a) mixing a ceramic mass or other mass which sets as a result of baking or sintering and which comprises at least one compound selected from the group consisting of alumina; aluminum nitride; aluminum carbide; cordierite; mullite; silicon carbide; silicon boride; silicon nitride; titanium dioxide; titanium carbide; boron carbide; boron oxide; talc; silicon metal; carbon black; graphite; rare earth oxides and zeolites, with
(A) at least one cellulose ether,
(B) at least one plasticizer selected from the group consisting of casein; polycarboxylic acids and salts thereof; polymers which comprise both carboxylic acid monomers or their salts and carboxylate ether monomers, carboxylic ester monomers and other carboxylic acid derivatives, crosslinking bisacrylates and similar monomers; and mixtures of the before-mentioned plasticizers, and
(C) at least one defoamer selected from the group consisting of alkylene glycol homopolymers, copolymers, terpolymers and block copolymers; adducts of alkylene oxides; alkylene glycol ethers of higher alcohols; fatty acid esters; alkylene glycol fatty acid esters; sorbitol fatty acid esters; polyoxyalkylene sorbitol fatty acid esters; addition products of ethylene oxide and propylene oxide and acetylene; phosphate esters; all compounds containing polyether groups or mixtures containing polyether groups which have a defoaming action; and mixtures thereof,
as individual components or as premixed additive and
b) subsequently extruding it.

2. The process according to claim 1, wherein cellulose ethers having a viscosity of from 400 to 200 000 mPa·s, determined in an 2% by weight aqueous solution at 20° C., are used as cellulose ether (A).

3. The process according to claim 1, wherein polycarboxylic acid copolymers and/or salts thereof are used as plasticizer (B).

4. The process according to claim 1, wherein defoamers based on polyether are used as defoamer (C).

5. The process according to claim 4, wherein alkylene glycol homopolymers, copolymers, terpolymers or block copolymers are used as defoamer based on polyether.

6. The process according to claim 1, wherein, based on the total amount of (A), (B) and (C), the proportion of component (A) is from 10 to 91% by weight, that of component (B) is from 8 to 70% by weight and that of component (C) is from 1 to 20% by weight.

7. The process according to claim 1, wherein the amount of (A), (B) and (C), viewed as a mixture, used is from 1 to 8% by weight based on the total formulation of the ceramic mass or other mass which sets as a result of baking or sintering.

8. The process according to claim 1, wherein a thermal treatment of the extrudate is carried out after extrusion.

9. An extrudate obtainable by a process claim 1.

10. (canceled)

11. (canceled)

12. An additive for the extrusion of ceramic masses or other masses which set as a result of baking or sintering, which comprises (A) at least one cellulose ether,
(B) at least one polycarboxylic acid copolymer and/or salt thereof as plasticizer and
(C) at least one defoamer selected from the group consisting of alkylene glycol homopolymers, copolymers, terpolymers and block copolymers; adducts of alkylene oxides; alkylene glycol ethers of higher alcohols;
fatty acid esters; alkylene glycol fatty acid esters; sorbitol fatty acid esters;
polvoxyalkylene sorbitol fatty acid esters; addition products of ethylene oxide and propylene oxide and acetylene; phosphate esters; all compounds containing polyether groups or mixtures containing polyether groups which have a defoaming action; and mixtures thereof.

13. The process according to claim 3, wherein defoamers based on polyether are used as defoamer (C).

14. The process according to claim 13, wherein, based on the total amount of (A), (B) and (C), the proportion of component (A) is from 10 to 91% by weight, that of component (B) is from 8 to 70% by weight and that of component (C) is from 1 to 20% by weight.

15. The process according to claim 14, wherein the amount of (A), (B) and (C), viewed as a mixture, used is from 1 to 8% by weight based on the total formulation of the ceramic mass or other mass which sets as a result of baking or sintering.

16. A honeycomb body for exhaust gas treatment or a catalyst comprising the extrudate as claimed in claim 9.

17. A ceramic mass or other mass which set as a result of baking or sintering, manufactured by
a) mixing a ceramic mass or other mass which sets as a result of baking or sintering and which comprises at least one compound selected from the group consisting of alumina; aluminum nitride; aluminum carbide; cordierite; mullite; silicon carbide;
silicon boride; silicon nitride; titanium dioxide; titanium carbide; boron carbide;
boron oxide; talc; silicon metal; carbon black; graphite; rare earth oxides and zeolites, with
(A) at least one cellulose ether,
(B) at least one plasticizer selected from the group consisting of casein; polycarboxylic acids and salts thereof; polymers which comprise both carboxylic acid monomers or their salts and carboxylate ether monomers, carboxylic ester monomers and other carboxylic acid derivatives, crosslinking bisacrylates and similar monomers; and mixtures of the before-mentioned plasticizers, and
(C) at least one defoamer selected from the group consisting of alkylene glycol homopolymers, copolymers, terpolymers and block copolymers; adducts of alkylene oxides; alkylene glycol ethers of higher alcohols; fatty acid esters; alkylene glycol fatty acid esters; sorbitol fatty acid esters; polyoxyalkylene sorbitol fatty acid esters; addition products of ethylene oxide and propylene oxide and acetylene; phosphate esters; all compounds containing polyether groups or mixtures containing polyether groups which have a defoaming action; and mixtures thereof,
as individual components or as premixed additive.
